(19) United States
(12) Patent Application Publication
(10) Pub. No.: US 2008/0175588 A1
(43) Pub. Date: Jul. 24, 2008

(54) Method and apparatus for analyzing a network or a network element fault

(75) Inventors: Marc R. Bernard, Miramar, FL (US); Michael J. Wurst, Santa Rosa, CA (US); Douglas A. Atkinson, Ashburn, VA (US); Michael Giovannoni, Great Falls, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 11/784,427

(22) Filed: Apr. 6, 2007

Related U.S. Application Data
(60) Provisional application No. 60/873,626, filed on Dec. 8, 2006.

(51) Int. Cl. H04B 10/08

(52) U.S. Cl. 398/17

(57) ABSTRACT

Common techniques for restoring service to an optical network after a service interruption, while quick, do not to assist a service provider or a vendor in determining a true root-cause of the interruption. Oftentimes, the true root-cause remains undetermined, resulting in costly and unnecessary fixes. In contrast, an example embodiment of the invention facilitates troubleshooting and determining the true root-cause of the service interruption by: i) collecting and storing state information about a PON element prior to analyzing a fault attributed to the PON element, and ii) diagnosing a cause of the fault from the state information.

### RELATED APPLICATIONS

This application claims the benefit of U.S. Provisional Application No. 60/873,626 entitled “METHOD AND APPARATUS FOR ANALYZING A NETWORK OR A NETWORK ELEMENT FAULT,” filed on Dec. 8, 2006. The entire teachings of the above application are incorporated herein by reference.

### BACKGROUND OF THE INVENTION

In an optical network, such as a Passive Optical Network (PON), when an optical network element fails, such as an Optical Network Terminal (ONT), often the failed element is simply replaced with another. Such a technique restores service quickly, but does so at the expense of not determining the true root-cause of the failure. In fact, replacing a failed element is often unnecessary or, worse yet, fails to restore service. Other techniques include power cycling a failed optical network element to force a hard reset or issuing a reboot command. Again, these techniques may restore service quickly (if at all), but fail to determine (or at the very least fail to assist in determining) the true root-cause of the failure.

### SUMMARY OF THE INVENTION

A method and corresponding apparatus for diagnosing a Passive Optical Network (PON) fault is provided. A method according to an example embodiment of the present invention includes: i) collecting state information about a PON element prior to analyzing a fault attributed to the PON element; ii) storing the state information about the PON element prior to analyzing the fault attributed to the PON element; and iii) diagnosing a cause of the fault from the collected and stored state information. The collected and stored state information facilitates a technician or automates troubleshooting and true root-cause analysis of an ONT which has been presumed to have failed. Thus, in some embodiments, an amount of time needed to diagnose the PON fault is reduced.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram of an example passive optical network (PON);

FIG. 2 is a block diagram of an example configuration process implemented by an element management system (EMS), in accordance with an example embodiment of the present invention;

FIG. 3A is a flow diagram of an example process performing a corresponding diagnostic action in an event a reboot command is issued, in accordance with an example embodiment of the present invention;

FIG. 3B is a flow diagram of another example process performing a corresponding diagnostic action in an event a reboot command is issued, in accordance with an example embodiment of the present invention;

FIG. 4 is a flow diagram of an example process performing a corresponding diagnostic action in an event an initialization command is issued, in accordance with an example embodiment of the present invention;

FIG. 5A is a flow diagram of an example process performing a corresponding diagnostic action in an event an emergency stop (E-STOP) command is issued, in accordance with an example embodiment of the present invention;

FIG. 5B is a flow diagram of another example process performing a corresponding diagnostic action in an event an emergency stop (E-STOP) command is issued, in accordance with an example embodiment of the present invention;

FIG. 6A is a flow diagram of an example process performing a corresponding diagnostic action in an event a loss of alternating current/direct current (AC/DC) power is detected, in accordance with an example embodiment of the present invention;

FIG. 6B is a flow diagram of another example process performing a corresponding diagnostic action in an event a loss of AC/DC power is detected, in accordance with an example embodiment of the present invention;

FIG. 7 is a flow diagram of an example process performing a corresponding diagnostic action in an event a diagnostics timer expires, in accordance with an example embodiment of the present invention;

FIG. 8 is a flow diagram of an example process of a technician issuing a diagnostic command to an ONT locally, in accordance with an example embodiment of the present invention;

FIG. 9 is a block diagram of an element management system (EMS) collecting state information about a PON element under diagnosis to analyze a PON fault attributed to the PON element, in accordance with an example embodiment of the present invention;

FIGS. 10A and 10B are flow diagrams of example processes for diagnosing a PON fault, in accordance with example embodiments of the present invention; and

FIG. 11 is a block diagram of an example apparatus to diagnose a PON fault, in accordance with an example embodiment of the present invention.

### DETAILED DESCRIPTION OF THE INVENTION

A description of example embodiments of the invention follows.

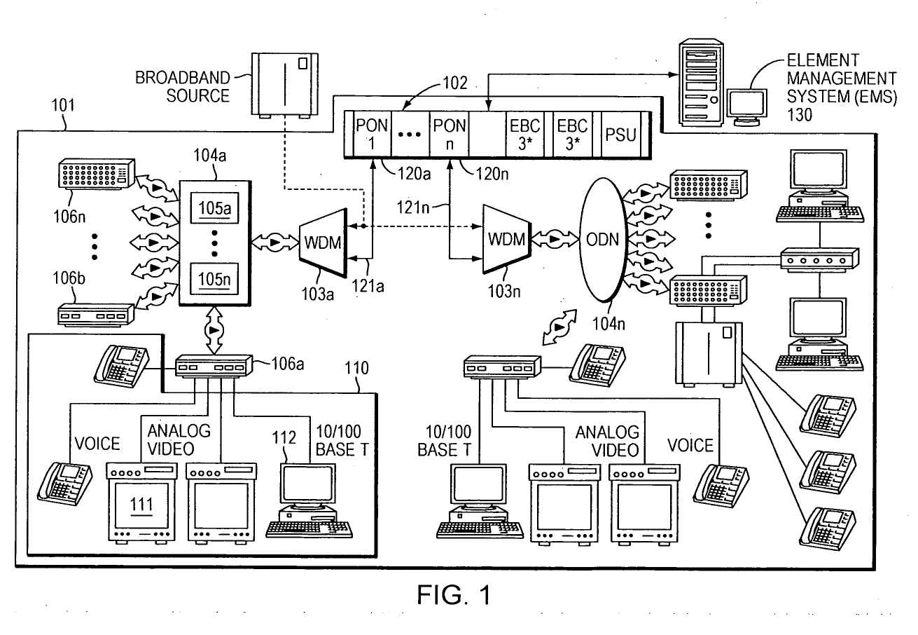

FIG. 1 is a network diagram of an exemplary passive optical network (PON) 101. The PON 101 includes an optical line terminal (OLT) 102, wavelength division multiplexers 103a-n, optical distribution network (ODN) devices 104a-n, ODN device splitters (e.g., 105a-n associated with ODN device 104a), optical network terminals (ONTs) (e.g., 106-n corresponding to ODN device splitters 105a-n), and customer premises equipment (e.g., 110). The OLT 102 includes PON cards 120a-n, each of which provides an optical feed (121a-n) to ODN devices 104a-n. Optical feed 121a, for example, is distributed through corresponding ODN device 104a by separate ODN device splitters 105a-n to respective ONTs 106a-n in order to provide communications to and from customer premises equipment 110.

The PON 101 may be deployed for fiber-to-the-business (FTTB), fiber-to-the-curb (FTTC), and fiber-to-the-home (FTTH) applications. The optical feeds 121a-n in PON 101 may operate at bandwidths such as 155 Mb/sec, 622 Mb/sec, 1.25 Gb/sec, and 2.5 Gb/sec or any other desired bandwidth implementations. The PON 101 may incorporate asynchronous transfer mode (ATM) communications, broadband services such as Ethernet access and video distribution, Ethernet point-to-multipoint topologies, and native communications of data and time division multiplex (TDM) formats. Customer premises equipment (e.g., 110) which can receive and provide communications in the PON 101 may include standard telephones (e.g., Public Switched Telephone Network (PSTN)), Internet Protocol telephones, Ethernet units, video devices (e.g., 111), computer terminals (e.g., 112), digital subscriber line connections, cable modems, wireless access, as well as any other conventional device.

A PON 101 includes one or more different types of ONTs (e.g., 106a-n). Each ONT 106a-n, for example, communicates with an ODN device 104a through associated ODN device splitters 105a-n. Each ODN device 104a-n in turn communicates with an associated PON card 120a-n through respective wavelength division multiplexers 103a-n. Wavelength division multiplexers 103a-n are optional components which are used when video services are provided. Communications between the ODN devices 104a-n and the OLT 102 occur over a downstream wavelength and an upstream wavelength. The downstream communications from the OLT 102 to the ODN devices 104a-n may be provided at 622 megabytes per second, which is shared across all ONTs connected to the ODN devices 104a-n. The upstream communications from the ODN devices 104a-n to the PON cards 120a-n may be provided at 155 megabytes per second, which is shared among all ONTs connected to ODN devices 104a-n.

FIG. 1 further illustrates the OLT 102 managed by an element management system (EMS) 130. Since the OLT 102 includes the PON cards 120a-n, each PON card 120a-n is also managed by the EMS 130. As such, a single EMS may manage all PON cards within a PON.

A single EMS, however, may manage or otherwise be associated with more than one PON. As such, a single EMS is not limited to managing PON cards within a single PON, but may manage PON cards from several PONs.

In an event a fault or a problem occurs in the PON 101, such as an interruption in customer or subscriber services, typically an ONT (e.g., the ONT 106) is replaced, but oftentimes unnecessarily. In addition to replacing an ONT, the primary means for restoring services quickly include rebooting the ONT, cross-connect killing/rebuilding the ONT, or resetting a port on the ONT. While service is returned quickly, the true root-cause of the fault, however, goes undetermined.

Prior art solutions to solving a fault include a technician simply power cycling the alternating current (AC) and/or direct current (DC) power for an ONT and forcing a hard reboot. Power cycling the ONT may resolve or otherwise remove the fault. However, power cycling the ONT does not provide any type of information, such as state or diagnostic information about the ONT, with which to determine the true root-cause of the fault. That is to say, simply removing a fault does not explain why there was a fault. In fact, the true root-cause of the fault might not be caused by the ONT at all, but may be caused by a Broadband Home Router (BHR), an Optical Line Terminal (OLT), or some other network element located in a PON.

Other solutions include a technician simply removing an ONT (and possibly a BHR) from a PON and returning the ONT to manufacturing. The technician then simply replaces the ONT with another ONT, which may or may not experience the same faults or problem as before. Again, without state or diagnostic information about the ONT, the true root-cause of a fault remains undetermined.

Alternatively, a reboot or initialization command may be issued, for example, from an OLT (e.g., the OLT 102) or a PON card (e.g., the PON 120a-n). A reboot command causes an ONT to perform a local reboot, whereas an initialization command from an element management system (EMS) (e.g., the EMS 130) causes the OLT or the PON card to un-range and then re-range the ONT.

While troubleshooting and diagnostics techniques such as reviewing alarm logs, performance monitoring histories, and error counters may be performed, such techniques fail to facilitate a technician in troubleshooting and analyzing the true root-cause of presumably failed ONTs. For example, collecting and storing PON-wide configurations and network configurations, such as a grant map for a PON card, a type of each ONT on a PON, a common language equipment identifier (CLEI) of each ONT on the PON, a software version of each ONT on the PON, a bandwidth assigned to each ONT on the PON, and services configured for each ONT on the PON, may allow a vendor to duplicate a service provider's network to replicate or otherwise reproduce a fault. With the fault reproduced, the vendor is able to try, for example, creating fixes, patches or solutions to characterize the fault. Logs, histories, statistics, counters, and the like, alone, merely provide evidence that a fault exists. In contrast, other information, such as state and diagnostic information (described in greater detail below), provide evidence of why the fault exists. Oftentimes, knowing why a fault exists is just as or more important than knowing simply a fault exists.

Accordingly, what is needed is a troubleshooting and diagnostic technique which addresses these and others scenarios or situations. For example, in an event connectivity between an OLT and an ONT is still established, a diagnostic state of the ONT can be determined remotely (e.g., through debug commands, see Appendix). In this way, the remotely determined diagnostic state of the ONT may be used to diagnose the root cause of a service interruption or issue.

In another example, in an event connectivity between an OLT to an ONT is lost; the diagnostic state of a still powered ONT can be determined by an on-site technician through an existing or newly implemented port. Alternatively, the on-site technician can determine the diagnostic state through existing or newly implemented visual indicators, such as light emitting diodes (LEDs) or display. In this way, the diagnostic state, which may be determined on-site, is used to diagnose the true root-cause of a service interruption or issue.

In yet another example, in an event power to an ONT is lost, connectivity to a stored record of the diagnostic state of an ONT is maintained (e.g., in FLASH memory or other non-volatile random access memory (NVRAM)). The diagnostic state of the ONT can then be retrieved from the stored record, for example, prior to removing the ONT (i.e., on-site retrieval) or after the ONT is returned to the manufacturer. In this way, prior to the ONT losing power and being removed from the PON, the stored record of the diagnostic state of the ONT may be used to diagnose the true root-cause of a service interruption or issue.

In addition to determining a diagnostic state of an ONT, in some instances, configuration information for other ONTs on a PON, such as type, parameters enabled, and status information, are collected and stored. In this way, PON-wide configurations, even network-wide configurations, may be used to diagnose the true root-cause of a service interruption or issue.

To provide a brief overview, certain embodiments of the present invention focus on the ability to diagnose PON faults, including general ONT issues and interruptions in subscriber services (e.g., voice, data and/or video) by collecting and storing state or diagnostic information. Such diagnostic information is either stored on an ONT or on an OLT (or on a PON card). Additionally, certain embodiments of the present invention address features on the ONT, OLT, and an element management system (EMS) which facilitate troubleshooting by a technician and true root-cause analysis of a presumably failed ONT.

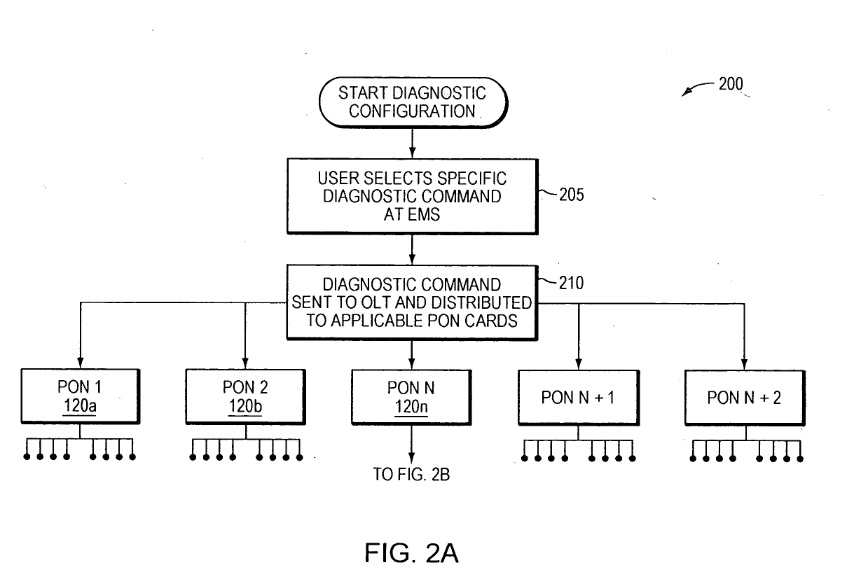

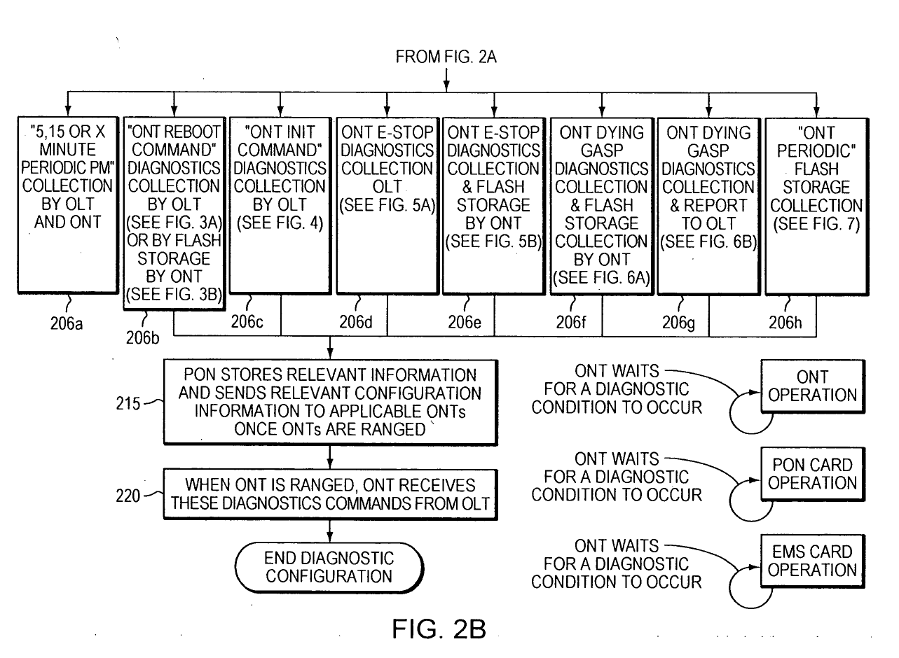

FIG. 2 is a flow diagram 200 illustrating an example diagnostic configuration process implemented by an element management system (EMS), such as the EMS 130 of FIG. 1. A user at the EMS selects (205) a diagnostic command 206a-h (generally 206) requesting that a diagnostic action be performed in an event a corresponding diagnostic condition occurs (described and illustrated in greater detail below). The selected diagnostic command 206 may be on a per-ONT, per-PON card, per-OLT or PON-wide basis. That is to say the occurrence of the diagnostic condition and the performance of the diagnostic action may be limited in scope to a particular ONT, OLT, PON or system. Further, the user may select (205) more than one diagnostic command 206 (described later in greater detail). Moreover, the process may make the selected diagnostic command 206 a permanent parameter until specified differently at the EMS 130.

In this example, the selected diagnostic command 206 is on a per-PON card basis. As such, the occurrence of the diagnostic condition and the performance of the diagnostic action are limited in scope to a particular PON card (e.g., the PON card 120 of FIG. 1) in an OLT (e.g., the OLT 102 of FIG. 1). The EMS sends (210) the selected diagnostic command 206 to the OLT, which in turn is distributed to the applicable PON card. The diagnostic command 206 is then sent to each ONT in communications with or otherwise in association with the applicable PON card.

The PON card 120 may also stores and sends (215) configuration information relevant to the diagnostic command 206 to the applicable ONTs once the ONTs are ranged. Once ranged, the ONTs receive (220) the diagnostic command 206 from the PON card 120. In this way, each ONT is instructed that in an event a diagnostic condition occurs, a corresponding diagnostic action be performed. In doing so, the diagnostic configuration process of FIG. 2 assists in troubleshooting and in determining the true root-cause of a PON fault.

For the sake of readability the following terms are defined and used hereinafter. A PON element under diagnosis (e.g., an ONT) refers to a PON element whose attributed fault has not been analyzed yet, but is to be the subject of fault analysis in an event a diagnostic condition occurs. State information about the PON element under diagnosis is information prior to analyzing a fault attributed to the PON element.

State information about a PON element includes, but is not limited to, diagnostic information about the PON element, such as local diagnostics, performance monitoring information (e.g., errors on an interface and dropped data), statistics, and alarms. Moreover, it should be understood that state information collected and stored by various embodiments of the present invention also includes, but is not limited to, diagnostic information, such as those detailed by the Fault, Configuration, Accounting, Performance, and Security (FCAPS) management categories of the International Organization for Standardization (ISO) Telecommunications Management Network (TMN) model and framework for network management. The terms state information and diagnostic information are used interchangeably throughout the disclosure and is not intended to be limiting.

Continuing with a detailed description of various embodiments of the present invention, in an event a particular diagnostic condition occurs, a particular diagnostic action is performed. For example, in an event an administrator or other user issues a reboot command, the diagnostic act of collecting and storing diagnostic information about an ONT under diagnosis is performed. That is, the state information about the ONT, prior to analyzing a fault attributed to the ONT, is collected and stored when the reboot command is issued. However, in an event a loss of power is detected, the diagnostic act of sending a “dying gasp” command in a Physical Layer Operations, Administration, and Maintenance (PLOAM) message is performed instead. In this way, it is said that in an event a diagnostic action occurs, a diagnostic action corresponding to the occurrence is performed. In other words, for a given diagnostic condition there is a corresponding diagnostic action.

It should be noted that multiple diagnostic conditions may occur in sequence, and hence multiple diagnostic actions may be performed in sequence. Consider the example of a first diagnostic condition occurring when an administrator or user issues a reboot command and a subsequent second diagnostic condition occurring when a loss of power is detected. A diagnostic act corresponding to the first diagnostic condition is first performed by collecting and storing diagnostic information about an ONT under diagnosis. A diagnostic act corresponding to the second diagnostic condition is subsequently performed by sending a “dying gasp” command in a Physical Layer Operations, Administration and Maintenance (PLOAM) message.

It should also be noted, similar to performing a single diagnostic action in an event a single diagnostic condition occurs, in certain embodiments of the present invention, in an event a sequence of diagnostic conditions occur, a sequence of diagnostic actions is performed to assist in troubleshooting and in determining the true root-cause of a PON fault.

As previously discussed, the ability to troubleshoot or otherwise diagnose a PON fault and to determine the true root-cause of the PON fault stem from the ability to collect and store state information, such as diagnostics information about a PON element under diagnosis, and in some instances, state information about other PON elements in a PON.

Typically, there is more than one source of diagnostic information about a PON element under diagnosis. For example, a first source of diagnostic information is the PON element under diagnosis itself (e.g., an ONT) and a second source of diagnostic information is another PON element (e.g., a PON card or an OLT). As such, diagnostic information about the PON element under diagnosis as it is known to itself is said to be “local” diagnostic information. In contrast, diagnostic information about the PON element under diagnosis as it is known to the other PON element is said to be “non-local” diagnostic information. Both local and non-local diagnostic information provide information regarding the diagnostic state of the PON element under diagnosis, but from different “perspectives.” As such, how the other PON element perceives the PON element under diagnosis may differ from how the PON element under diagnosis perceives itself.

Such a difference in perspective may arise because the type of diagnostic information which is local and which is non-local may differ from one another. For example, local diagnostic information may be of a narrower type and thus provides a narrow or local perspective. In contrast, non-local diagnostic information may be of a broader type and thus provides a broad or global perspective. Such a difference in perspectives of diagnostic information may be used to troubleshoot a PON fault.

Moreover, a difference in local and non-local diagnostic information may still arise even if both are of the same type because their diagnostic values may differ from one another or otherwise mismatch. Such a mismatch in diagnostic information may also be used to troubleshoot a PON fault.

As such, the ability to collect and subsequently to store diagnostics information about a PON element under diagnosis from the PON element under diagnosis itself and another PON element may greatly facilitate troubleshooting and determining the true root-cause of a PON fault. However, it may not always be possible or necessary to collect and store both local and non-local diagnostic information, as later discussed.

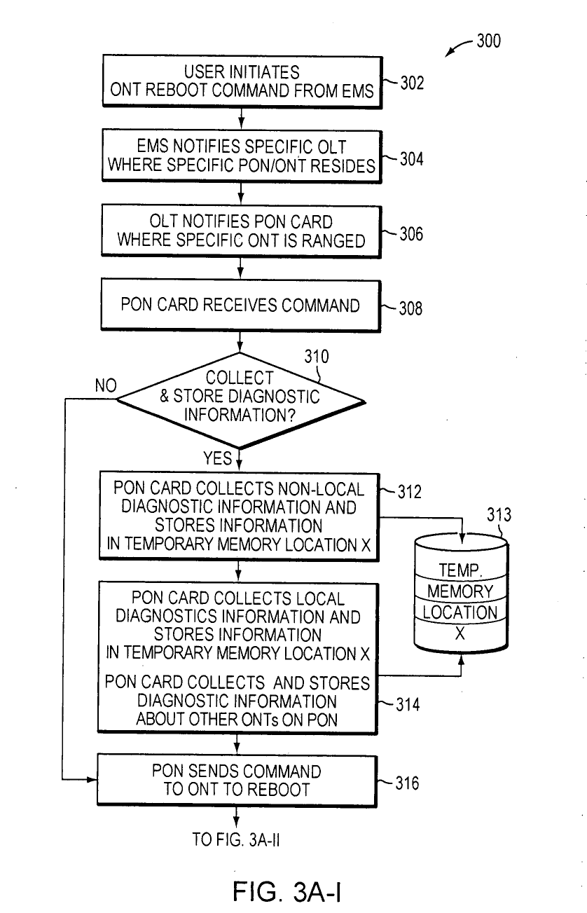

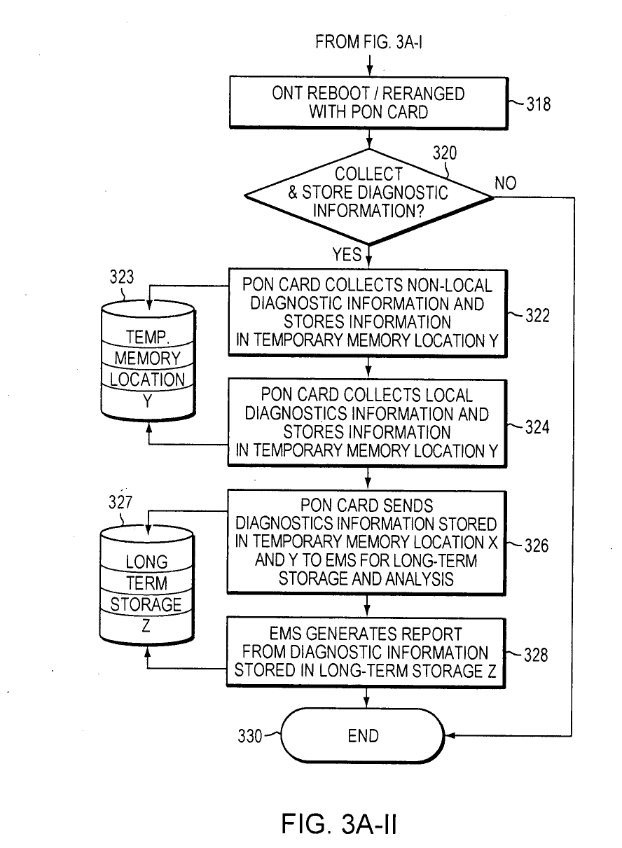

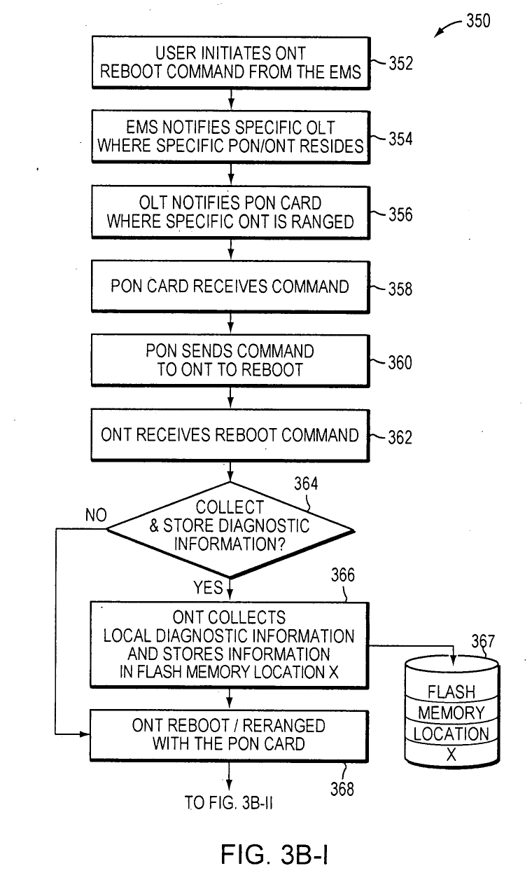

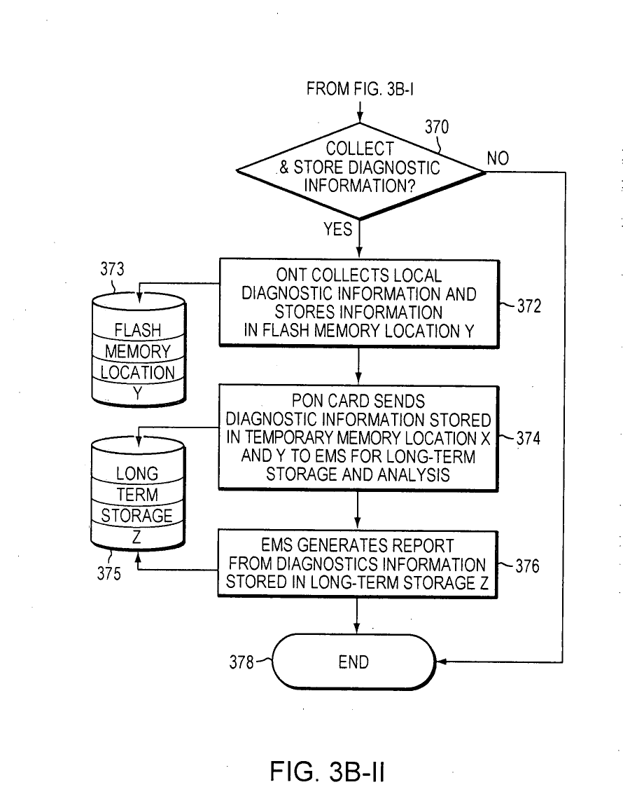

FIG. 3A is a flow diagram 300 illustrating a passive optical network (PON) element, such as a PON card, performing a corresponding diagnostic action on a PON element under diagnosis, such as an optical network terminal (ONT), in an event an administrator or other user issues a reboot command.

A user initiates (302) a reboot command from an element management system (EMS) directing the ONT under diagnosis to reboot. The EMS notifies (304) a specific optical line terminal (OLT) where the ONT under diagnosis resides. The OLT notifies (306) a specific PON card where the ONT under diagnosis is ranged.

The PON card receives (308) the reboot command directing the ONT under diagnosis to reboot. The PON card determines (310) whether to collect and store diagnostic information about the ONT. If the PON card determines (310) to collect and store diagnostic information about the ONT, the PON card collects and stores (312) non-local diagnostic information about the ONT, such as local diagnostics, performance monitoring (PM), statistics, alarms, and provisioning information. In this way, the collected and stored non-local diagnostic information, such as provisioning information, may be compared. The collected non-local diagnostic information about the ONT is stored locally in a temporary memory location X 313.

The PON card collects and stores (314) local diagnostic information about the ONT under diagnosis. The local diagnostic information is collected or otherwise retrieved from the ONT under diagnosis and stored locally in the temporary memory location X 313. In this way, diagnostic information about the ONT under diagnosis, as it is known to the ONT itself and as it is known to the PON card (or alternatively an OLT), is collected and stored, and is thus used to diagnose a PON fault.

In addition to local and non-local diagnostic information about the ONT under diagnosis, the PON card also collects and stores (314) diagnostic information about other ONTs on the PON, such as type, parameters enabled, and status information. Such diagnostic information is also temporarily stored in the temporary memory location X 313. In this way, diagnostic information about the ONT under diagnosis and other ONTs on the PON are collected and stored before rebooting the ONT under diagnosis.

Oftentimes service interruptions and issues do not result from a single ONT, but from multiple ONTs on a PON, which may or may not affect the overall behavior of the PON. Not only does collecting and storing diagnostic information about other ONTs on the PON, in addition to an ONT under diagnosis, allow a service provider to refer to it, such diagnostic information also allows a vendor to re-test scenarios or conditions causing the service interruption. In this way, a PON fault can be pinpointed and located specifically whether the fault is located in the ONT, on the PON, or in the network.

One skilled in the art will readily recognize that it is within the contemplation of various embodiments of the present invention to include the ability to collect and store PON-wide configurations and network configurations. For example, an embodiment of the present invention collects and stores a grant map for a PON card, a type of each ONT on a PON, a common language equipment identifier (CLEI) of each ONT on the PON, a software version of each ONT on the PON, a bandwidth assigned to each ONT on the PON, and services configured for each ONT on the PON. As another example, an embodiment of the present invention collects and stores non-PON OLT variables, such as uplink information and software versions.

By storing such information, either periodically or in an event a certain diagnostic condition occurs, it is useful for a vendor to troubleshoot a service provider's network. Consider the following example: information about a service provider's entire network is collected and stored periodically, e.g., once a day or some other configured period of time. A vendor with such information now knows the progressive steps taken by the service provider in configuring the service provider's overall network. In this way, the vendor can now follow or otherwise duplicate the same steps to find and troubleshoot a fault quickly.

Returning to FIG. 3A, the PON card issues (316) or otherwise sends a reboot command. The PON card reboots (318) or otherwise re-ranges the ONT under diagnosis.

The PON card determines (320) whether to collect and store diagnostic information about the ONT under diagnosis. If the PON card determines (320) to collect and store diagnostic information about the ONT under diagnosis, the PON card collects and stores (322) non-local diagnostic information about the ONT, such as local diagnostics, performance monitoring (PM), statistics, alarms, and provisioning information. In this, the collected and stored non-local diagnostic information, such as provisioning information, may be compared. The collected non-local diagnostic information about the ONT under diagnosis is stored locally in a temporary memory location Y 323.

The PON card also collects and stores (324) local diagnostic information. The local diagnostic information is collected or otherwise retrieved from the ONT under diagnosis and stored locally in the temporary memory location Y 323. In this way, information about the ONT under diagnosis after the ONT is rebooted, as it is known to the ONT itself and as it is known to the PON card, is collected and stored, and thus may be used to diagnose a PON fault.

The PON card sends (326) the diagnostic information stored in the temporary memory locations X 313 and Y 323 to the EMS for storage in a long-term storage Z 327. In this way, diagnostic information about a PON element under diagnosis and other PON elements before and after the PON element under diagnosis reboots is known, and thus may be used to diagnose a PON fault.

In an alternative embodiment, the diagnostic states of a PON element under diagnosis and a PON, as they exists before and after the PON element under diagnosis reboots, are known and may be used to determine the true root-cause of a service interruption or issue.

The EMS generates (328) a report for the ONT under diagnosis from the diagnostic information stored in the long-term storage Z 327. The generated report may be used by a vendor or a service provider to develop procedures for handling and processing an ONT which is presumed to have failed.

Alternatively, diagnostic information about a PON element under diagnosis or other PON elements on a PON is not collected and stored before a reboot command is issued. For example, in FIG. 3A, in an event the PON card determines (310) not to collect and store diagnostic information about an ONT under diagnosis and other ONTs on a PON, the PON card issues (316) a reboot command to the ONT under diagnosis without collecting and storing such information (312 and 314, respectively).

Similarly, diagnostic information about a PON element under diagnosis is not collected and stored after the PON element under diagnosis reboots. For example, in FIG. 3A, in an event the PON card determines (320) not to collect and store diagnostic information about an ONT under diagnosis, the flow diagram 300 ends (330) without collecting and storing (322 and 324, respectively) such information in the temporary memory location Y 323, and without sending (326) such information to the long-term storage Z 327.

In summary, the PON card may issue the reboot command causing the ONT under diagnosis to reboot without collecting or storing information about the ONT under diagnosis. Furthermore, information may not be collected and stored before issuing the reboot command or after the ONT reboots. Moreover, information may not be collected and stored both before issuing the reboot command and after the ONT reboots.

In an alternative embodiment, even in an event a diagnostic condition occurs, such as issuing a reboot command, a diagnostic action corresponding to the diagnostic condition, such as collecting and storing local and non-local diagnostic information about a PON element under diagnosis (and other PON elements on a PON), may be selectively performed. For example, in an event there is nothing wrong with the PON element under diagnosis and/or the PON (i.e., there is no PON fault), but nevertheless it is decided to reboot the PON element under diagnosis (e.g., to upgrade the PON element), the diagnostic act of collecting and storing information about the PON element to be rebooted (and other PON elements on the PON) may be unnecessary and thus de-selected.

FIG. 3B is a flow diagram 350 illustrating a passive optical network (PON) element, such as a PON card, performing a corresponding diagnostic action on a PON element under diagnosis, such as an optical network terminal (ONT), in an event an administrator or other user issues a reboot command.

A user initiates (352) a reboot command from an element management system (EMS) directing the ONT under diagnosis to reboot. The EMS notifies (354) a specific optical line terminal (OLT) where the ONT under diagnosis resides. The OLT notifies (356) a specific PON card where the ONT under diagnosis is ranged.

The PON card receives (358) a reboot command directing the ONT under diagnosis reboot. The PON card issues (360) or otherwise sends a reboot command.

The ONT under diagnosis receives (362) the reboot command directing the ONT to reboot. In contrast to the flow diagram 300, instead of a PON card, the ONT under diagnosis determines (364) whether to collect and store local diagnostic information about the ONT. If the ONT under diagnosis determines (364) to collect and store local diagnostic information, the ONT collects and stores (366) local diagnostic information, such as local diagnostics, performance monitoring (PM), statistics, alarms, and provisioning information. In this way, the collected and stored local diagnostic information, such as provisioning information, may be compared. The collected local diagnostic information about the ONT under diagnosis is stored locally in a non-volatile random access memory (NVRAM) or FLASH memory location X (367).

The ONT under diagnosis reboots (368) or otherwise is re-ranged by the PON card.

The ONT under diagnosis determines (370) whether to collect and store local diagnostic information. If the ONT under diagnosis determines (370) to collect and store local diagnostic information, the ONT collects and stores (372) local diagnostic information, such as local diagnostics, performance monitoring (PM), statistics, alarms, and provisioning information. In this way, the collected and stored local diagnostic information, such as provisioning information, may be compared. The collected local diagnostic information about the ONT under diagnosis is stored locally in a non-volatile FLASH memory location Y (373).

The PON card sends (374) the diagnostic information stored in the FLASH memory locations X 367 and Y 373 to the EMS for storage in a long-term storage Z 375. In this way, diagnostic information about a PON element under diagnosis and other PON elements before and after the PON element under diagnosis reboots is known, and thus may be used to diagnose a PON fault.

In an alternative embodiment, the diagnostic state of a PON element under diagnosis, as it exists before and after the PON element under diagnosis reboots, is known and may be used to determine the true root cause of a service interruption or issue.

The EMS generates (376) a report for the ONT under diagnosis from the diagnostic information stored in the long-term storage Z 375. The generated report may be used by a vendor or a service provider to develop procedures for handling and processing an ONT which is presumed to have failed.

Alternatively, diagnostic information about a PON element under diagnosis is not collected and stored before a reboot command is issued. For example, in FIG. 3B, in an event the ONT under diagnosis determines (364) not to collect and store local diagnostic information, the ONT reboots (368) without collecting and storing such information (366).

Similarly, diagnostic information about a PON element under diagnosis is not collected and stored after a PON element under diagnosis reboots. For example, in FIG. 3B, in an event the ONT under diagnosis determines (370) not to collect and store local diagnostic information, the flow diagram 350 ends (378) without collecting and storing (366) such information in the non-volatile FLASH memory location Y 373, and without sending (374) such information to the long-term memory storage Z 375.

In summary, the ONT under diagnosis may reboot without collecting or storing local diagnostic information. Furthermore, local diagnostic information may not be collected and stored before the reboot command issues or after the ONT reboots. Moreover, local diagnostic information may not be collected and stored both before the reboot command issues and after the ONT reboots.

In an alternative embodiment, even in an event a diagnostic condition occurs, such as a reboot command issues, a diagnostic action corresponding to the diagnostic condition, such as collecting and storing local diagnostic information about a PON element under diagnosis, may be selectively performed. For example, in an event there is nothing wrong with the PON element under diagnosis (i.e., there is no PON fault), but nevertheless it is decided to reboot the PON element under diagnosis (e.g., to upgrade the PON element), the diagnostic act of collecting and storing local diagnostic information about the PON element to be rebooted may be unnecessary and thus de-selected.

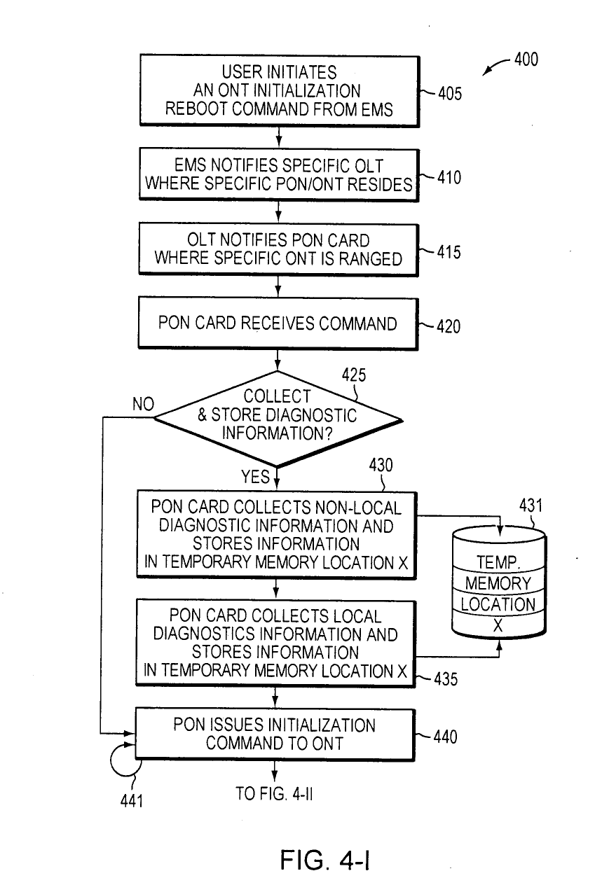

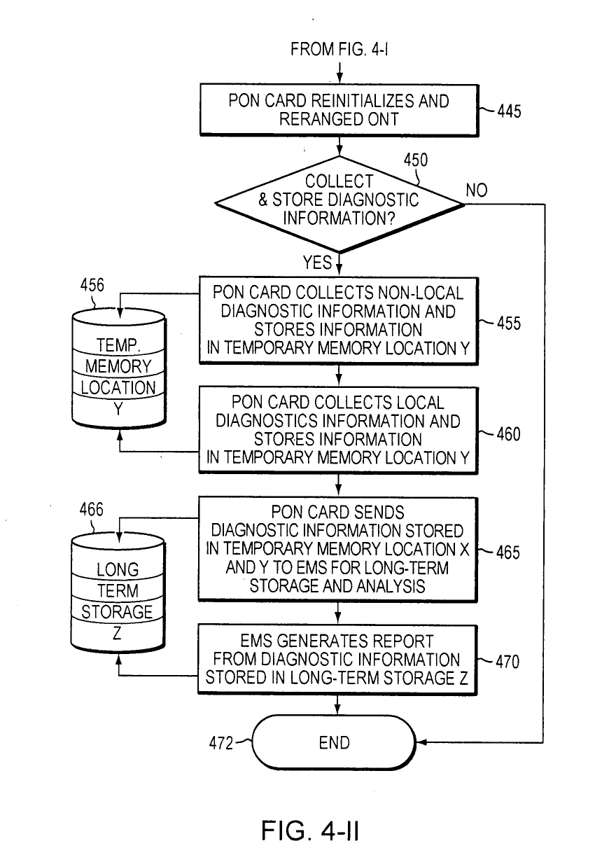

FIG. 4 is a flow diagram 400 illustrating a passive optical network (PON) element, such as a PON card, performing a corresponding diagnostic action on a PON element under diagnosis, such as an optical network terminal (ONT), in an event an administrator or other user issues an initialization command.

A user initiates (405) an initialization command from an element management system (EMS) directing the ONT under diagnosis to re-initialize. The EMS notifies (410) a specific optical line terminal (OLT) where the ONT under diagnosis resides. The OLT notifies (415) a specific PON card where the ONT under diagnosis is ranged.

The PON card receives (420) an initialization command directing the ONT under diagnosis to re-initialize. The PON card determines (425) whether to collect and store diagnostic information about the ONT. If the PON card determines (425) to collect and store information about the ONT under diagnosis, the PON card collects and stores (430) non-local diagnostic information about the ONT, such as local diagnostics, performance monitoring (PM), statistics, alarms, and provisioning information. In this way, the collected and stored non-local diagnostic information, such as provisioning information, may be compared. The collected non-local diagnostic information about the ONT under diagnosis is stored locally in a temporary memory location X 431.

The PON card collects and stores (435) local diagnostic information about the ONT under diagnosis. The local diagnostic information is collected or otherwise retrieved from the ONT under diagnosis and stored locally in the temporary memory location X 431. In this way, diagnostic information about the ONT under diagnosis before the ONT is re-initialized, as it is known to the ONT itself and as it is known the PON card (or alternatively an OLT), is collected and stored, and thus may be used to diagnose a PON fault.

The PON card issues (440) an initialization command or otherwise deactivates the ONT under diagnosis. The PON card waits (441) for a configurable amount of time before proceeding forward. The PON card re-initializes (445) or otherwise activates and re-ranges the ONT under diagnosis.

The PON card determines (450) whether to collect and store diagnostic information about the ONT under diagnosis. If the PON card determines (450) to collect and store diagnostic information about the ONT under diagnosis, the PON card collects and stores (455) non-local diagnostic information about the ONT, such as local diagnostics, performance monitoring (PM), statistics, alarms, and provisioning information. The non-local diagnostic information about the ONT under diagnosis collected is stored locally in a temporary memory location Y 456.

The PON card also collects and stores (460) local diagnostic information. The local diagnostic information is collected or otherwise retrieved from the ONT under diagnosis and stored locally in the temporary memory location Y 456. In this way, information about the ONT under diagnosis after the ONT is re-initialized, as it is known to the ONT itself and as it is known to the PON card (or alternatively the OLT), is collected and stored, and thus may be used to diagnose a PON fault.

The PON card sends (465) the diagnostic information stored in the temporary memory locations X 431 and Y 456 to the EMS for long-term storage in a long-term storage Z 466. In this way, diagnostic information about a PON element under diagnosis before and after the PON element under diagnosis is re-initialized is known, and thus may be used to diagnosis a PON fault.

In an alternative embodiment, the diagnostic state of a PON element under diagnosis, as it exists before and after the PON element under diagnosis re-initializes, is known and may be used to determine the true root-cause of a service interruption or issue.

The EMS generates (470) a report for the ONT under diagnosis from the diagnostic information stored in the long-term storage Z 466. The generated report may be used by a vendor or a service provider to develop procedures for handling and processing an ONT which is presumed to have failed.

Alternatively, diagnostic information about a PON element under diagnosis is not collected and stored before an initialization command is issued. For example, in FIG. 4, in an event the PON card determines (425) not to collect and store diagnostic information about an ONT under diagnosis, the PON card issues (440) a initialization command to the ONT without collecting and storing such information (430 and 435, respectively).

Similarly, diagnostic information about a PON element under diagnosis is not collected and stored after the PON element under diagnosis re-initializes. For example, in FIG. 4, in an event the PON card determines (450) not to collect and store diagnostic information about an ONT under diagnosis, the flow diagram 400 ends (472) without collecting and storing (455 and 460, respectively) such information in the temporary memory location Y 456, and without sending (465) such information to the long-term storage Z 466.

In summary, the PON card may issue an initialization command causing the ONT under diagnosis to re-initialize without collecting or storing diagnostic information about the ONT. Furthermore, information may not be collected and stored before issuing the initialization command or after the ONT under diagnosis re-initializes. Moreover, information may not be collected and stored both before issuing the initialization command and after the ONT re-initializes.

In an alternative embodiment, even in an event a diagnostic condition occurs, such as issuing an initialization command, a diagnostic action(s) corresponding to the diagnostic condition, such as collecting and storing local and non-local diagnostic information about a PON element under diagnosis may be selectively performed. For example, in an event there is nothing wrong with the PON element under diagnosis or the PON (i.e., there is no PON fault), but nevertheless it is decided to re-initialize the PON element under diagnosis, the diagnostic act of collecting and storing information about the PON element to be re-initialized may be unnecessary and thus de-selected.

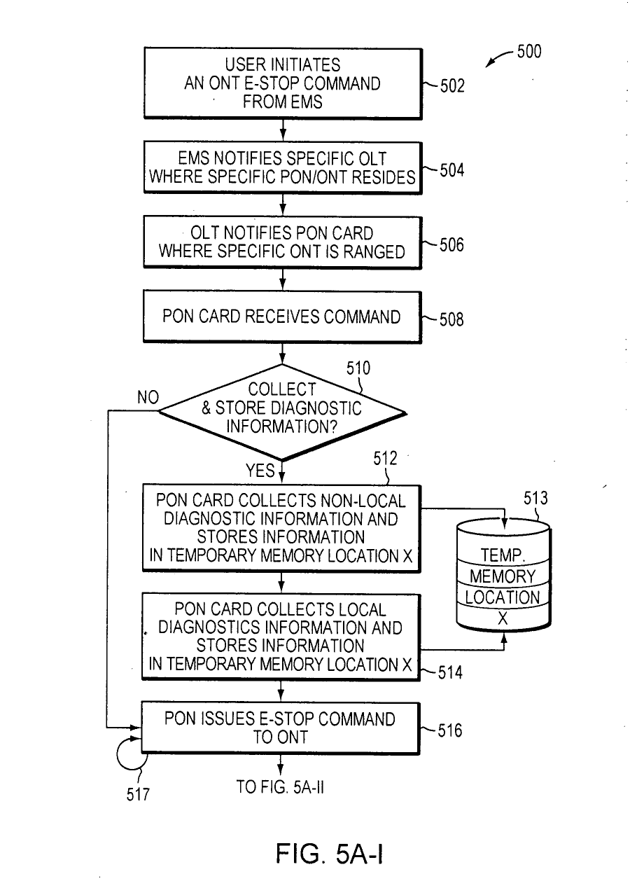

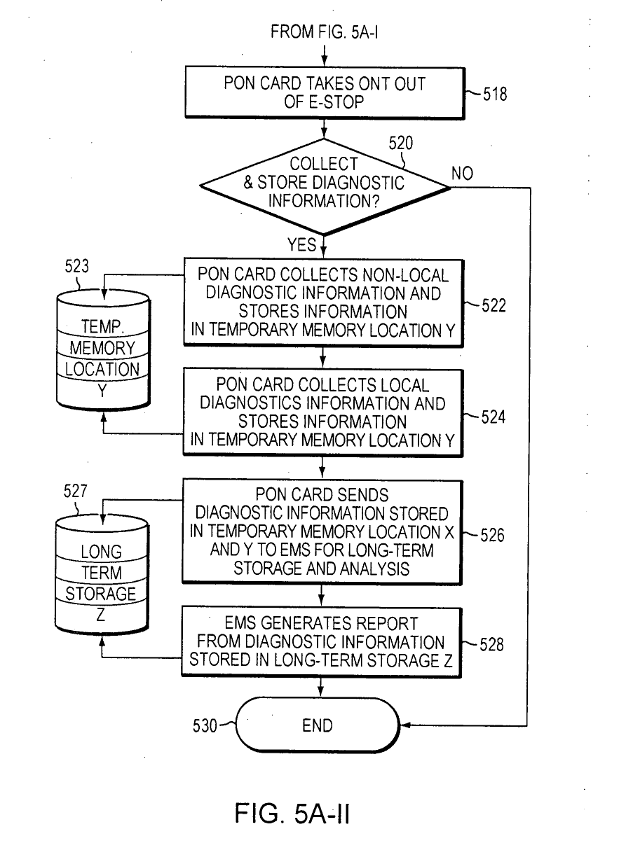

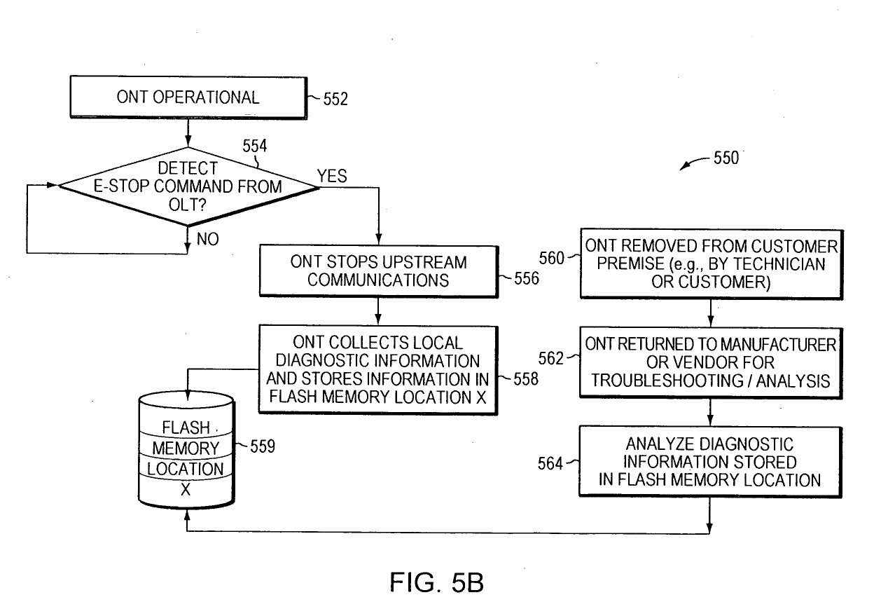

FIG. 5A is a flow diagram 500 illustrating a passive optical network (PON) element, such as a PON card, performing a corresponding diagnostic action on a PON element under diagnosis, such as an optical network terminal (ONT), in an event an administrator or other user issues an emergency stop (E-STOP) command.

A user initiates (502) an E-STOP command from an element management system (EMS) directing the ONT under diagnosis to stop transmitting data upstream or otherwise stop upstream communications. The EMS notifies (504) a specific optical line terminal (OLT) where the ONT under diagnosis resides. The OLT notifies (506) a specific PON card where the ONT under diagnosis is ranged.

The PON card receives (508) the E-STOP command directing the ONT under diagnosis to stop upstream communications. The PON card determines (510) whether to collect and store diagnostics information about the ONT under diagnosis. If the PON card determines (510) to collect and store diagnostic information about the ONT under diagnosis, the PON card collects and stores (512) non-local diagnostic information about the ONT, such as local diagnostics, performance monitoring (PM), statistics, alarms, and provisioning information. In this way, the collected and stored non-local diagnostic information, such as provisioning information, may be compared. The collected non-local diagnostic information about the ONT is stored locally in a temporary memory location X 513. In this way, non-local diagnostic information about the ONT under diagnosis is collected and stored before upstream communications stops.

The PON card also collects and stores (514) local diagnostic information about the ONT under diagnosis. The local diagnostic information is collected or otherwise retrieved from the ONT under diagnosis and stored locally in the temporary memory location X 513. In this way, diagnostic information about the ONT under diagnosis, as it is known to the ONT itself and as it is known to the PON card (or alternatively the OLT), is collected and stored, and thus may be used to diagnose a PON fault.

The PON card issues (516) the E-STOP command or otherwise stops upstream communications. The PON card waits (517) either for a configurable amount of time before preceding forward or waits for the administrator or other user to send another command to take the ONT under diagnosis out of the E-STOP-ON state (e.g., E-STOP-OFF) and re-start upstream communications. The PON card restarts (518) upstream communications of the ONT under diagnosis or otherwise takes the ONT out of the E-STOP-ON state.

The PON card determines (520) whether to collect and store diagnostic information about the ONT under diagnosis. If the PON card determines (520) to collect and store diagnostic information about the ONT under diagnosis, the PON card collects and stores (522) non-local diagnostic information about the ONT, such as local diagnostics, performance monitoring (PM), statistics, alarms, and provisioning information. In this way, the collected and stored non-local diagnostic information, such as provisioning information, may be compared. The collected non-local diagnostic information about the ONT under diagnosis is stored locally in a temporary memory location Y 523.

The PON card also collects and stores (524) local diagnostic information. The local diagnostic information is collected or otherwise retrieved from the ONT under diagnosis and stored locally in the temporary memory location Y 523. In this way, diagnostic information about the ONT under diagnosis after upstream communications restarts, as it is known to the ONT itself and as it is known to the PON card (or alternatively the OLT), is collected and stored, and thus may be used to diagnose a PON fault. As such, information about the ONT under diagnosis is collected and stored after upstream communications of the ONT under diagnosis restarts.

The PON card sends (526) the diagnostic information stored in the temporary memory locations X 513 and Y 523 to the EMS for long-term storage in a long-term storage Z 527. In this way, diagnostic information about a PON element under diagnosis before upstream communications stops and after upstream communications restarts is known, and thus may be used to diagnose a PON fault.

In an alternative embodiment, the diagnostic state of a PON element under diagnosis, as it exists before and after upstream communications stops and restarts, is known and may be used to determine the true root-cause of a service interruption or issue.

The EMS generates (528) a report for the ONT under diagnosis from the information stored in the long-term storage Z 527. The generated report may be used by a vendor or a service provider to develop procedures for handling and processing an ONT which is presumed to have failed.

Alternatively, local diagnostic and non-local diagnostic information about a PON element under diagnosis is not collected and stored before an E-STOP command is issued. For example, in FIG. 5A, in an event the PON card determines (510) not to collect and store diagnostics information about an ONT under diagnosis, the PON card issues (516) an E-STOP command to the ONT without collecting and storing such information (512 and 514, respectively).

Similarly, local diagnostic and non-local diagnostic information about a PON element under diagnosis is not collected and stored after upstream communications re-starts. For example, in FIG. 5A, in an event the PON card determines (520) not to collect and store diagnostics information about an ONT under diagnosis, flow diagram 500 ends (530) without collecting and storing (522 and 524, respectively) such information in the temporary memory location Y 523, and without sending (526) such information to the long-term storage Z 527.

In summary, the PON card may issue the E-STOP command causing the ONT under diagnosis to stop upstream communications without collecting or storing diagnostic information about the ONT. Furthermore, diagnostic information may not be collected and stored before issuing the E-STOP command or after upstream communications restarts. Moreover, diagnostic information may not be collected and stored both before issuing the E-STOP command and after upstream communications restarts.

In an alternative embodiment, even in an event a diagnostic condition occurs, such as issuing an E-STOP command, a diagnostic action corresponding to the diagnostic condition, such as collecting and storing local and non-local diagnostic information about a PON element under diagnosis, may be selectively performed. For example, in an event there is nothing wrong with the PON element under diagnosis (i.e., there is no PON fault), but nevertheless it is decided to stop upstream communications of the PON element under diagnosis, the diagnostic act of collecting and storing information about the PON element to be issued an E-STOP command may be unnecessary and thus de-selected.

FIG. 5B is a flow diagram 550 illustrating a passive optical network (PON) element under diagnosis, such as an optical network terminal (ONT) performing a corresponding diagnostic action in an event the PON element under diagnosis detects an emergency stop (E-STOP) command from another PON element, such as a PON card or an optical line terminal (OLT).

An ONT under diagnosis is operational (552) or is otherwise sending upstream communications. The ONT under diagnosis determines (554) whether an E-STOP command from a PON card (or an OLT) is detected. If the ONT under diagnosis determines (554) that the E-STOP command is detected, the ONT stops (556) upstream communications (e.g., by disabling an upstream transmitter).

The ONT under diagnosis collects and stores (558) local diagnostic information, such as local diagnostics, performance monitoring (PM), statistics, alarms, and provisioning information. In this way, the collected and stored local diagnostic information, such as provisioning information, may be compared. The collected local diagnostic information is stored locally in a non-volatile FLASH memory location X 559.

The ONT under diagnosis may stop (556) upstream communications before or after the ONT collects and stores (558) the local diagnostic information. For example, in some instances, stopping (556) upstream communications is more useful than collecting and storing (558) local diagnostic information about the ONT under diagnose or vice versa. In this way, the precedence of diagnostic actions taken by the ONT under diagnosis may be configurable.

The ONT is removed (560) from a customer premise by a technician, or alternatively by a customer or subscriber, and is returned (562) to a vendor or a manufacturer. Assuming the ONT under diagnosis collects and stores (558) local diagnostic information, the vendor or the manufacturer analyzes (564) such diagnostic information which led to the ONT being removed (560). As such, local diagnostic information collected and stored after the ONT stopped upstream communications may be used to diagnose a PON fault.

In an alternative embodiment, the diagnostic state of a PON element under diagnosis, as it exists before upstream communications of the PON element stops, is collected and stored, and may be used to determine the true root-cause of a service interruption or issue.

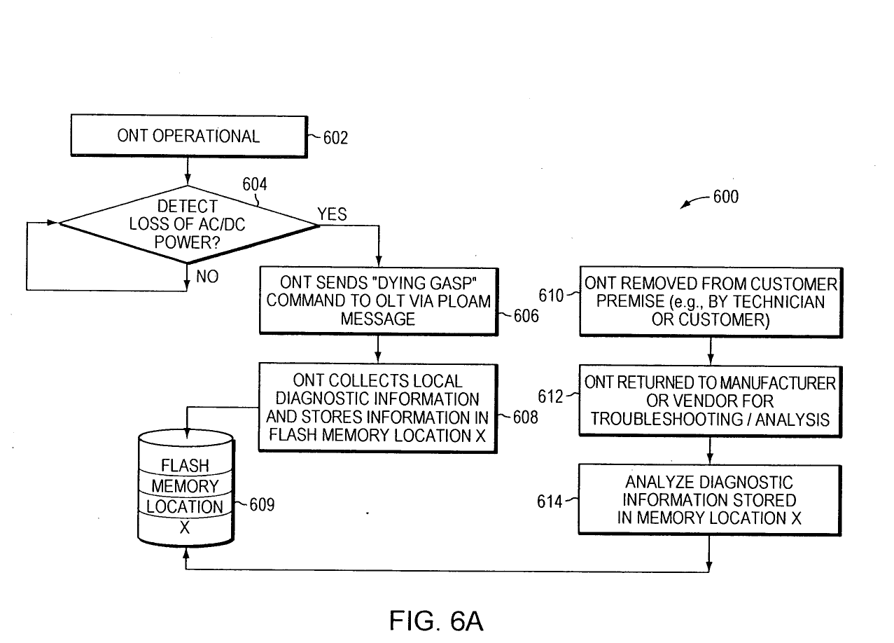

FIG. 6A is a flow diagram 600 illustrating a PON element under diagnosis, such as an optical network terminal (ONT), performing a corresponding diagnostic action in an event the PON element detects a loss of alternating current and/or direct current (AC/DC) power.

An ONT under diagnosis is operational (602) or is otherwise powered. The ONT under diagnosis determines (604) or otherwise detects a loss of AC/DC power. If the ONT under diagnosis detects (604) the loss of AC/DC power, the ONT sends (606) a “dying gasp” command or otherwise indicates the ONT is no longer operational to another PON element, such as a PON card (or an OLT) via a Physical Layer Operations, Administration and Maintenance (PLOAM) message.

The ONT under diagnosis collects and stores (608) local diagnostic information, such as local diagnostics, performance monitoring (PM), statistics, alarms, and provisioning information. In this way, the collected and stored local diagnostic information, such as provisioning information, may be compared. The collected local diagnostic information is stored locally in a non-volatile FLASH memory location X 609.

The ONT under diagnosis may send (606) the dying gasp command before or after the ONT collects and stores (608) the local diagnostic information. The ordering is a matter of capacitance of the ONT under diagnosis and/or what is more useful to a service provider or a vendor. In some instances, sending (606) the dying gasp command indicating the ONT under diagnosis is no longer operational is more useful than collecting and storing (608) local diagnostic information about the ONT or vice versa. In this way, the precedence of diagnostic actions taken by the ONT under diagnosis may be configurable.

The ONT is removed (610) from a customer premise by a technician or alternatively by a customer or subscriber, and is returned (612) to a vendor or a manufacturer. Assuming the ONT under diagnosis collects and stores (608) local diagnostic information, the vendor or the manufacturer analyzes (614) such diagnostic information which led to the ONT being removed (610). As such, local diagnostic information collected and stored after the ONT under diagnosis lost AC/DC power may be used to diagnose a PON fault.

In an alternative embodiment, the diagnostic state of a PON element under diagnosis, as it exists before the PON element under diagnosis lost AC/DC power (i.e., prior to sending a dying gasp command), is collected and stored, and may be used to determine the true root-cause of a service interruption or issue.

FIG. 6B is a flow diagram 650 illustrating a passive optical network (PON) element under diagnosis, such as an optical network terminal (ONT) performing a corresponding diagnostic action in an event the PON element under diagnosis detects a loss of alternating current and/or direct current (AC/DC) power.

An ONT under diagnosis is operational (652) or is otherwise powered. The ONT under diagnosis determines (654) or otherwise detects a loss of AC/DC power is detected. If the ONT under diagnosis detects (654) the loss of AC/DC power, the ONT sends (656) a “dying gasp” command or otherwise indicates the ONT is no longer operational to another PON element, such as a PON card (or an OLT) via a Physical Layer Operations, Administration and Maintenance (PLOAM) message.

The ONT under diagnosis collects and reports (658) local diagnostic information, such as local diagnostics, performance monitoring (PM), statistics, alarms, and provisioning information. In this way, the collected and stored local diagnostic information, such as provisioning information, may be compared. In contrast to the corresponding diagnostic action illustrated in FIG. 6A, the ONT under diagnosis does not store the collected local diagnostic information. Rather, the ONT under diagnosis reports the local diagnostic information about the ONT under diagnosis to another PON element, such as a PON card (or an OLT).

The PON card collects (or otherwise retrieves) and stores (660) diagnostic information about the ONT in a long-term memory location 661. An element management system (EMS) generates (662) a report for the ONT under diagnosis from the diagnostic information stored in the long-term storage 661. The generated report may be used by a vendor or a service provider to develop procedures for handling and processing an ONT which has been presumed to have failed.

Similar to the corresponding diagnostic action illustrated in FIG. 6A, the ONT under diagnosis may send (656) the dying gasp command before or after the ONT reports (658) the local diagnostic information. The ordering is a matter of capacitance of the ONT under diagnosis and/or what is more useful to a service provider or a vendor. In some instances, sending (656) the dying gasp command indicating that the ONT under diagnosis is no longer operational is more useful than reporting (658) local diagnostic information or vice versa. In this way, the precedence of diagnostic actions taken by the ONT under diagnosis may be configurable.

The ONT is removed (664) from a customer premise by a technician, or alternatively by a customer or subscriber, and is returned (666) to a vendor or a manufacturer. Assuming the ONT under diagnosis collects and reports (658) local diagnostic information, the vendor or the manufacturer analyzes (668) such diagnostic information which led to the ONT being removed (664). As such, local diagnostic information collected and stored after the ONT under diagnosis lost AC/DC power may be used to diagnose a PON fault.

In an alternative embodiment, the diagnostic state of a PON element under diagnosis, as it exists before the PON element under diagnosis lost AC/DC power (i.e., prior to the dying gasp command), is collected and reported, and may be used to determine the true root-cause of a service interruption or issue.

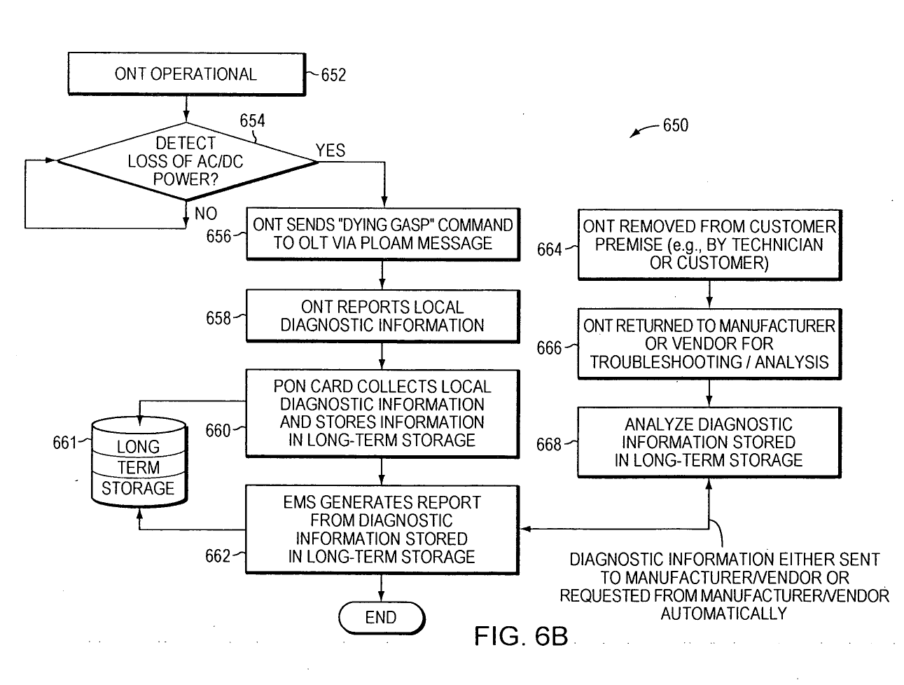

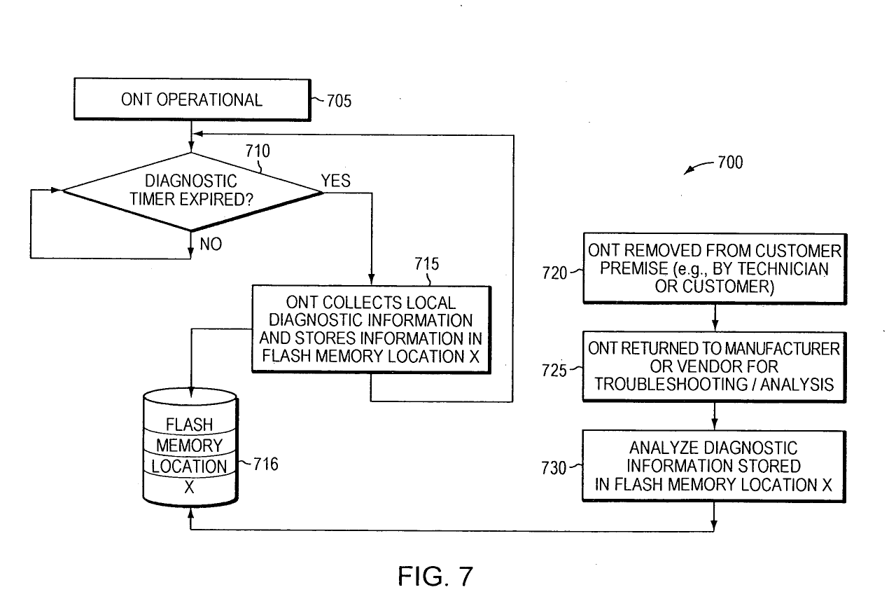

FIG. 7 is a flow diagram 700 illustrating a PON element under diagnosis, such as an optical network terminal (ONT), performing a corresponding diagnostic action in an event the PON element determines that a diagnostic timer expired

An ONT under diagnosis is operational (705). The ONT under diagnosis determines (710) whether the diagnostic timer expired. If the ONT under diagnosis determines (710) that the diagnostic timer expired, the ONT collects and stores (715) local diagnostic information, such as local diagnostics, performance monitoring (PM), statistics, alarms, and provisioning information. In this way, the collected and stored local diagnostic information, such as provisioning information, may be compared. The collected local diagnostic information is stored locally in a non-volatile FLASH memory location X 716.

The ONT under diagnosis may collect and store local diagnostic information about the ONT periodically for n periods. For example, the ONT collects local diagnostic information at 15 minute periods or intervals up to 8 hours, and stores such periodically collected diagnostic information up to 3 days before overwriting the collected diagnostic information. In this way, the ONT under diagnosis periodically collects and stores or otherwise logs local diagnostic information, while the ONT is operational.

The ONT is removed (720) from a customer premise by a technician or alternatively by a customer or subscriber, and is returned (725) to a vendor or a manufacturer. The vendor or the manufacturer analyzes (730) the diagnostic information which led to the ONT being removed (720). In this way, the collected and stored, or otherwise periodically logged, local diagnostic information may be used to diagnose a PON fault.

In an alternative embodiment, the diagnostic state of a PON element under diagnosis, as it exists before the PON element under diagnosis experiences a problem, is collected and stored, and may be used to determine the true root-cause of a service interruption or issue.

While previous figures illustrate various embodiments of the present invention within the context of a user interacting with otherwise managing a PON element under diagnosis from an element management system (EMS), those skilled in the art will readily recognize that the illustrated principles are also applicable in other contexts. For example, other means for managing, such as a craft user interface (CUI) on an optical network terminal (ONT) or an optical line terminal (OLT), are also within the contemplation of the invention. Accordingly, the present invention is not limited nor intended to be limited to managing the PON element under diagnosis from the EMS, but applies to cases where the element is managed locally as well.

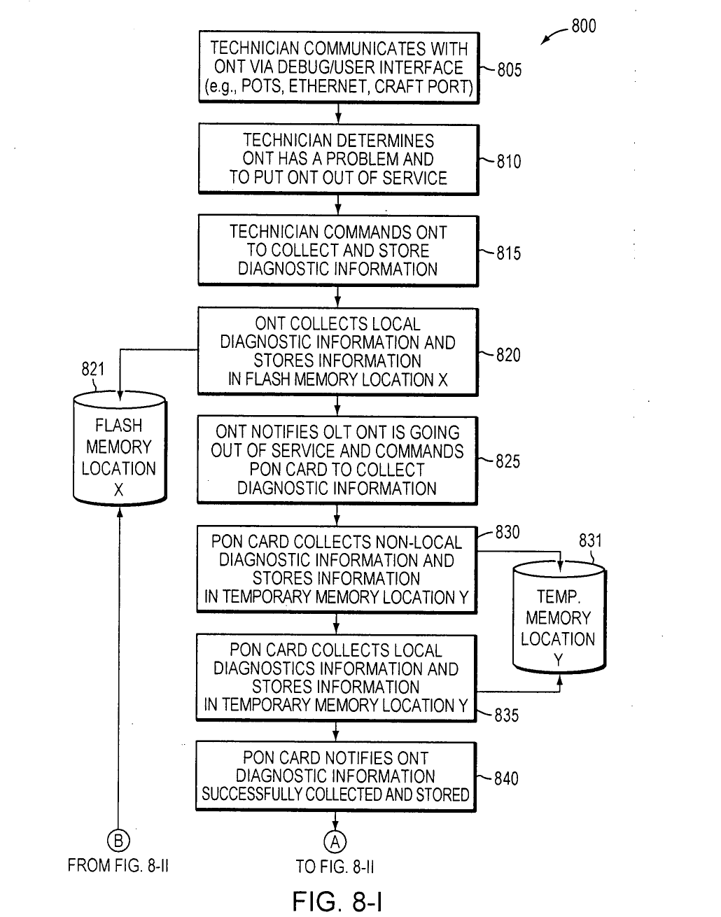

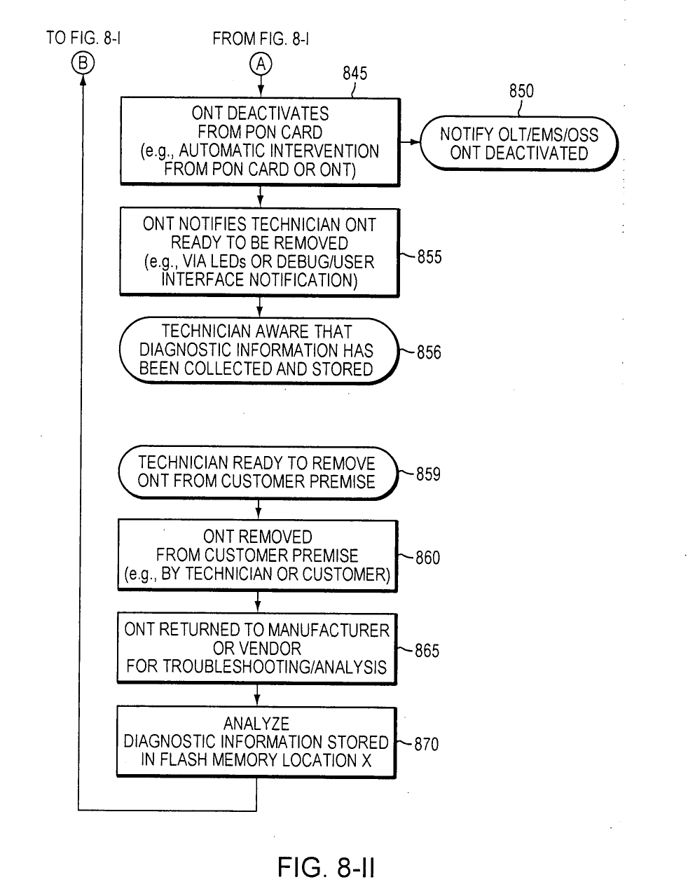

For example, FIG. 8 illustrates an example flow diagram 800 which considers the case where a technician (or other user) is capable of communicating locally with an optical network terminal (ONT) in a passive optical network (PON) through a communication port, a craft user interface (CUI), or other similar interface which is available through, for example, a plain old telephone service (POTS), Ethernet, or Craft.

In brief overview, the flow diagram 800 illustrates a technician issuing a command to the ONT (e.g., using a CUI) o collect diagnostic information and to store the diagnostic information in FLASH memory, for example. The ONT in turn sends a notification (or a command) to trigger a PON card (or alternatively an optical line terminal (OLT)) to collect and store local diagnostic information about the ONT. Additionally, non-local diagnostic information about the ONT may be collected or otherwise retrieved from the PON card (or alternatively the OLT). The collected and stored diagnostic information (local and non-local diagnostic information) may be used to generate reports and other diagnostics purposes.

The flow diagram 800 further illustrates the technician being notified of the completion of the diagnostic act of collecting and storing diagnostic information. The technician is notified, for example, via one or more light emitting diodes (LEDs) or through the CUI. The ONT is disconnected from the PON and returned to a vendor or a manufacturer for further assessment, diagnosis or testing.

In greater detail, the technician communicates (805) with an ONT under diagnosis via a debug/user interface (e.g., a CUI or a communication port available through POTS, Ethernet, or Craft). The technician determines (810) whether the ONT has a problem and/or whether to put the ONT out of service. In an event, the technician determines (810) the ONT has a problem and decides to put the ONT out of service, the technician commands (815) or otherwise causes the ONT to collect and store diagnostic information.

The ONT collects and stores (820) local diagnostic information about the ONT, such as local diagnostics, performance monitoring (PM), statistics, alarms, and provisioning information. In this way, the collected and stored local diagnostic information, such as provisioning information, may be compared. The collected local diagnostic information about the ONT is stored locally in a non-volatile FLASH memory location X 821.

The ONT under diagnosis notifies (825) the PON card (or alternatively the OLT) that the ONT is going out of service, and commands or otherwise directs a PON card (or alternatively the OLT) to collect and store diagnostic information about the ONT. The PON card (or alternatively the OLT) collects and stores (830) non-local diagnostic information about the ONT, such as local diagnostics, performance monitoring (PM), statistics, alarms, and provisioning information. The collected non-local diagnostic information about the ONT is stored locally in a temporary memory location Y 831.

The PON card (or alternatively the OLT) also collects and stores (835) local diagnostic information about the ONT under diagnosis. The local diagnostic information is collected or otherwise retrieved from the ONT and stored locally in the temporary memory location Y 831. In this way, diagnostic information about the ONT as it is known to the ONT itself and as it is known to the PON card (or alternatively the OLT), is collected and stored, and thus may be used to diagnose a PON fault.

The PON card (or alternatively the OLT) notifies (840) the ONT that diagnostic information about the ONT under diagnosis was successfully collected and stored. The ONT deactivates (845) from the PON card (or alternatively the OLT) through, for example, automatic intervention from the PON card (or alternatively the OLT) or from the ONT.

The ONT notifies (850) the PON card (or alternatively the OLT) that the ONT under diagnosis is deactivated by sending for example, a deactivation notification or other indication. Similarly, the ONT may also notify (850) an element management system (EMS) or an operations support system (OSS) that the ONT under diagnosis is deactivated by sending the deactivation notification.

The ONT further notifies (855) the technician that the ONT under diagnosis is ready to be removed using for example, one or more LEDs or a debug/user interface notification. In this way, the technician is aware (856) or otherwise alerted that diagnostic information about the ONT has been collected and stored, and the ONT may be removed.

The technician is ready (859) to remove the ONT from a customer premise. The ONT is removed (860) from the customer premise by the technician, or alternatively by a customer or subscriber. The ONT is returned (865) to a manufacturer or vendor for assessment, diagnostic testing, and/or other testing. With local and non-local diagnostic information collected and stored, the vendor or the manufacturer is able to analyze (870) the information leading to the ONT being removed (860). In this way, the collected and stored diagnostic information may be used to diagnose a PON fault.

In an alternative embodiment, the diagnostic state of a PON element under diagnosis, as it exists before the PON element under diagnosis is put out of service by a technician, is collected and stored, and may be used to determine the true root-cause of a service interruption or issue.

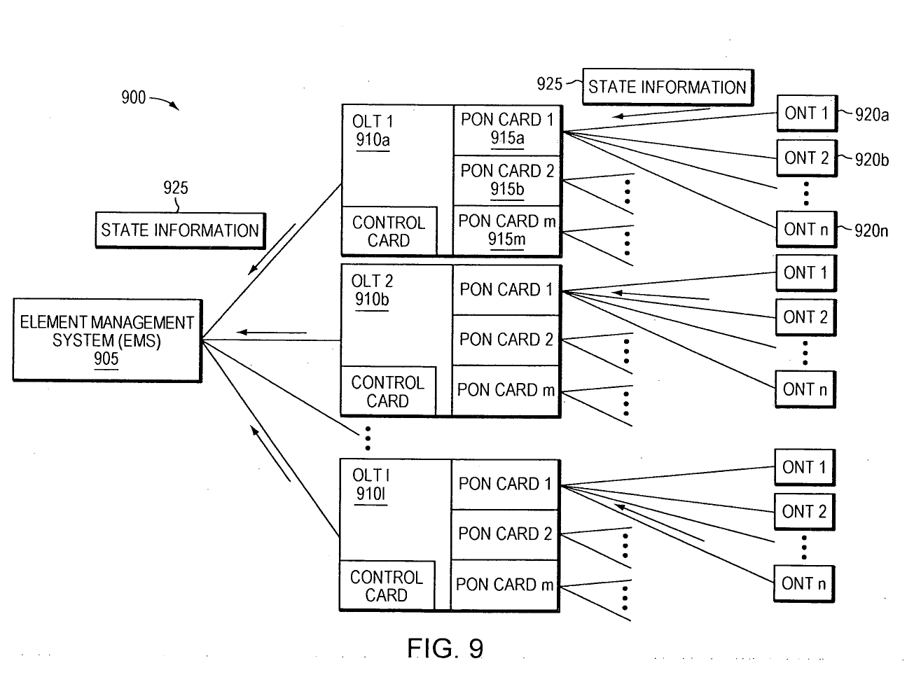

FIG. 9 illustrates an example block diagram 900 of an element management system (EMS) 905 managing l number of optical line terminals (OLTs) (910a . . . l, generally 910). Each OLT 910 having m number of passive optical network (PON) cards (915a . . . m, generally 915). Each PON card 915 is in communications (or otherwise associated) with n number of ONTs (920a . . . n, generally 920).

FIG. 9 further illustrates the EMS 905 and the OLT 910 collecting or otherwise retrieving state information 925 about a PON element, such as the ONT 920, prior to analyzing a fault attributed to the PON element. As described above, in an event a diagnostic condition occurs, the state information 925 may be collected and stored by the ONT 920 to be analyzed by the EMS 905. Alternatively, the state information 925 may be collected and stored by the PON card 915 to be analyzed by the EMS 905. As illustrated, the EMS 905 is able to collect (or otherwise aggregate) and store state information from more than one PON element under diagnosis, and thus may be used to determine the true root-cause of a service interruption or issue.

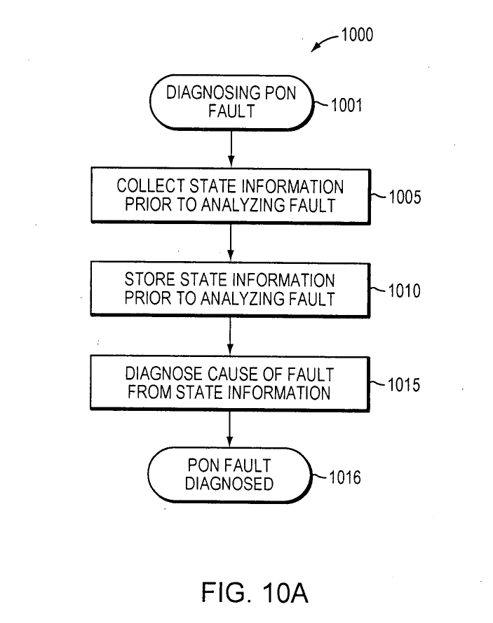

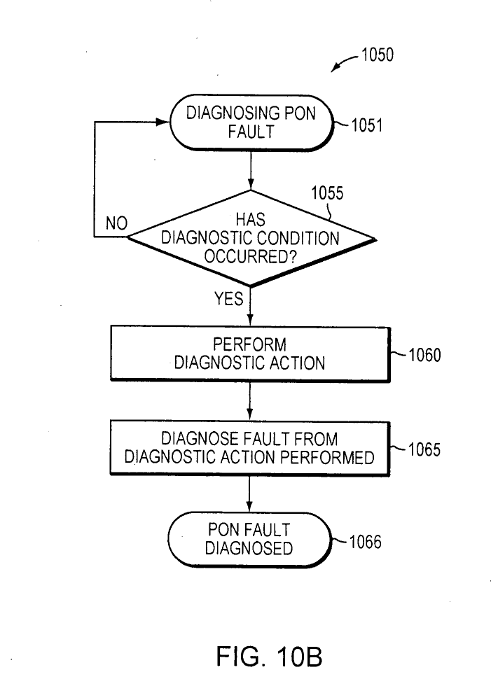

FIG. 10A illustrates an example flow diagram 1000 for diagnosing a passive optical network (PON) fault. The flow diagram 1000 starts (1001) diagnosing a PON fault. The flow diagram 1000 collects (1005) state information about a PON element prior to analyzing a fault attributed to the PON element. The flow diagram 1000 stores (1010) state information about the PON element prior to analyzing the fault attributed to the PON element. The flow diagram 1000 diagnoses (1015) a cause of the fault from the state information. The flow diagram 1000 ends (1016) with the PON fault diagnosed.

FIG. 10B illustrates an alternative flow diagram 1050 for diagnosing a passive optical network (PON) fault. The flow diagram 1050 starts (1051) diagnosing a PON fault. The flow diagram 1050 determines (1055) whether a diagnostic condition has occurred, such as whether a loss of power by a PON element has been detected or whether an issued command (e.g., a reboot command, an initialization command, and an emergency stop (E-STOP) command has been detected.

In an event the flow diagram 1050 determines (1055) a diagnostic condition has not occurred, the flow diagram 1050 starts (1051) again diagnosing a PON fault. However, in an event the flow diagram 1050 determines (1055) a diagnostic condition has occurred, the flow diagram 1050 performs (1060) a diagnostic action. For example, state information about a PON or a PON element, such as an optical network terminal (ONT), is collected and stored prior to analyzing the fault attributed to the PON or the PON element.

The flow diagram 1050 diagnoses (1065) a fault in the PON or attributed to the PON element from the diagnostic action performed. The flow diagram 1050 ends (1066) with the PON fault diagnosed.

The flow diagram 1050, unlike the flow diagram 1000 illustrated in FIG. 10A illustrate a flow diagram, is event-driven. That is whether a diagnostic action is performed depends on the occurrence of a diagnostic action. One skilled in the art will readily recognize that which diagnostic action is performed may also depend on which diagnostic condition occurred.

While troubleshooting and diagnostics techniques such as reviewing alarm logs, performance monitoring histories, and error counters may be performed, such techniques fail to facilitate a technician in troubleshooting and analyzing the true root-cause of presumably failed ONTs. Logs, histories, statistics, counters, and the like, or the fact something does not work anymore, merely provide evidence that a fault exists. In contrast, other information, such as state and diagnostic information, may provide evidence of why the fault exists.

Consider the following example. A PON element is functioning without any evidence of a fault, e.g., an error counter indicates zero packets dropped. There appears to be no fault. The PON element is upgraded to new version of software and is issued a reboot command to complete the upgrade. The PON element now experiences a fault, such as a memory leak, causing the PON element to crash or otherwise cease functioning. Beside the crash itself, the existence of the fault may be indicated, for example, by an error counter indicating packets dropped. There is, however, no indication of why the PON element crashed. That is, the cause of the memory leak is unknown from the error counter alone.

Consider the same example, but now apply the principles of the present invention. A diagnostic condition is determined when the PON element is issued the reboot command. A diagnostic action corresponding to the determined diagnostic condition is performed, for example, by saving a previous software version. In this example, the cause of the memory leak may be diagnosed, for example, by comparing the saved previous software version with the upgraded new version. Accordingly, in some embodiments, a PON fault may be diagnosed by determining whether a diagnostic condition has occurred independent of a fault occurring.

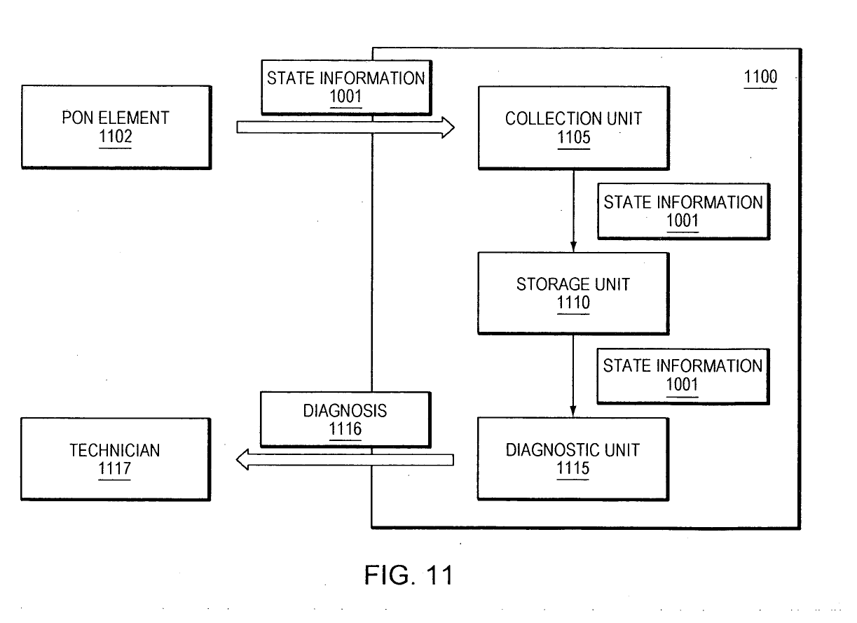

FIG. 11 illustrates an example apparatus 1100 to diagnose a passive optical network (PON) fault. The apparatus 1100 includes a collection unit 1105, storage unit 1110, and diagnostic unit 1115. The collection unit 1105 collects state information 1101 about a PON element 1102, for example an optical network terminal (ONT), prior to analyzing a fault attributed to the PON element 1102. The storage unit 1110 stores the state information 1101 about the PON element 1102 prior to analyzing the fault attributed to the PON element 1102. The diagnostic unit 1115 diagnoses a cause of the fault from the state information 1101. A resulting diagnosis 1116 may then be provided to a technician 1117, for example.

In one embodiment, the apparatus 1100 includes a detector (not shown) coupled to the collection unit 1105 and the storage unit 1110 to detect a loss of power by the PON element 1102 before the state information 1101 about the PON element 1102 is collected and stored. In this way, whether the detector detects a loss of power or not may also determine whether the collection unit 1105 and storage unit 1110 collect and store the state information 1101 about the PON element 1102.

In another embodiment, an interface (not shown) may be coupled to the detector and configured to send a “dying gasp” command from the PON element 1102 to another PON element, for example, an optical line terminal (OLT) in a Physical Layer Operations, Administration and Maintenance (PLOAM) message, in event a loss of power is detected. In this way, whether the detector detects a loss of power or not may further determine whether the “dying gasp” command is sent from the PON element 1102.

In yet another embodiment, the apparatus 1100 includes a timer (not shown) coupled to the collection unit 1105 and the storage unit 1110. The expiration of the timer determines a time for collecting and storing the state information 1101 about the PON element 1102. In this way, whether the timer has expired or not may also determine whether the collection unit 1105 and storage unit 1110 collect and store the state information 1101 about the PON element 1102.

One skilled in the art will readily recognize that the example apparatus 1100 may be co-located with or located separately from the PON element 1102. Furthermore, the collection unit 1105, storage unit 1110, and diagnostic unit 1115 of the example apparatus 1100 may be consolidated into fewer elements, or distributed amongst additional elements.

One or more of the above elements may be implemented in a microprocessor. Alternatively, one or more of the above elements may be implemented in software written to be executed by the microprocessor. One skilled in the art will readily recognize that where the above elements are implemented is not of significance, but rather what functions are performed by the above elements.

While this invention has been particularly shown and described with references to example embodiments thereof, it will be understood by those skilled in the art that various changes in form and details may be made therein without departing from the scope of the invention encompassed by the appended claims.

For example, although described as “cards” herein, it should be understood that passive optical network (PON) cards, optical line terminal (OLT) cards, or (optical network terminal (ONT) cards may be systems or subsystems without departing from the principles disclosed hereinabove.

Further, although described in reference to a passive optical network, the same or other example embodiments of the invention may be employed in an active optical network, data communications network, wireless network (e.g., between handheld communications units and a base transceiver station), or any other type of network.

In addition, the flow diagrams (e.g., FIGS. 2-8 and 10A-10B) may include more or fewer blocks, be arranged differently, or be represented differently. It should be understood that implementation may dictate the flow diagrams and the number of flow diagrams illustrating the execution of embodiments of the invention. For example, a single entity may implement embodiments of the invention. As such, the number of blocks may be fewer than illustrated.

What is claimed is:

1. A method for diagnosing a Passive Optical Network (PON) fault, the method comprising:
collecting state information about a PON element prior to analyzing a fault attributed to the PON element;
storing the state information about the PON element prior to analyzing the fault attributed to the PON element; and
diagnosing a cause of the fault from the state information.

2. The method of claim 1 wherein collecting and storing the state information about the PON element includes collecting and storing the state information before and after issuing a command to the PON element, the command selected from a group consisting of: a reboot command, an initialization command, and an emergency stop (E-STOP) command.

3. The method of claim 2 further comprising collecting and storing state information about other PON elements on the PON before issuing the command.

4. The method of claim 1 wherein storing the state information about the PON element includes storing the state information external from the PON element.

5. The method of claim 1 wherein storing the state information about the PON element includes storing the state information in the PON element in a non-volatile manner.

6. The method of claim 1 further comprising detecting a loss of power by the PON element before collecting and storing the state information about the PON element.

7. The method of claim 6 further comprising sending a “dying gasp” command from the PON element to another PON element via a Physical Layer Operations, Administration and Maintenance (PLOAM) message in an event a loss of power is detected.

8. The method of claim 1 further comprising determining a time for collecting and storing the state information about the PON element.

9. An apparatus to diagnose a Passive Optical Network (PON) fault, the apparatus comprising:
a collection unit to collect state information about a PON element prior to an analysis of a fault attributed to the PON element;
a storage unit coupled to the collection unit to store the state information about a PON element prior to an analysis of the fault attributed to the PON element; and
a diagnostic unit coupled to the storage unit to diagnose a cause of the fault from the state information.

10. The apparatus of claim 9 wherein the collection unit and the storage unit are configured to collect and store the state information before and after a command, selected from a group consisting of: a reboot command, an initialization command, and an emergency stop (E-STOP) command, is issued to the PON element.

11. The apparatus of claim 10 wherein the collection unit and the storage unit are further configured to collect and store state information about other PON elements on the PON before the command is issued.

12. The apparatus of claim 9 wherein the storage unit is configured to store the state information external from the PON element.

13. The apparatus of claim 9 wherein the storage unit is configured to store the state information in a non-volatile manner.

14. The apparatus of claim 9 further comprising a detector coupled to the collection unit and the storage unit to detect a loss of power by the PON element before the state information about the PON element is collected and stored.

15. The apparatus of claim 14 further comprising an interface coupled to the detector and configured to send a “dying gasp” command from the PON element to another PON element via a Physical Layer Operations, Administration, and Maintenance (PLOAM) message in an event a loss of power is detected.

16. The apparatus of claim 9 further comprising a timer coupled to the collection unit and the storage unit, the expiration of which determines a time for collecting and storing the state information about the PON element.

17. A method for diagnosing a Passive Optical Network (PON) fault, the method comprising:
determining whether a diagnostic condition has occurred independent of a fault occurring;
performing a corresponding diagnostic action in an event the diagnostic condition has occurred; and
diagnosing a cause of the fault in a PON or attributed to a PON element from the diagnostic action performed.

18. The method of claim 17 wherein determining whether the diagnostic condition has occurred includes detecting a loss of power by the PON element.

19. The method of claim 17 wherein determining whether the diagnostic condition has occurred includes detecting an issued command selected from a group consisting of: a reboot command, an initialization command, and an emergency stop (E-STOP) command.

20. The method of claim 17 wherein performing the diagnostic action includes collecting and storing state information about the PON or the PON element prior to analyzing the fault attributed to the PON or the PON element.

21. The method of claim 20 further comprising sending a “dying gasp” command from the PON element to another PON element via a Physical Layer Operations, Administration, and Maintenance (PLOAM) message.

22. A computer program product comprising a computer usable medium embodying computer usable code to diagnoses a Passive Optical Network (PON) fault, the computer program product including computer usable program code, which when executed by a processor, causes the processor to:
collecting state information about a PON element prior to analyzing a fault attributed to the PON element;
storing the state information about the PON element prior to analyzing the fault attributed to the PON element; and
diagnosing a cause of the fault from the state information.
